(19) United States
(12) Patent Application Publication
(10) Pub. No.: US 2022/0198516 A1
(43) Pub. Date: Jun. 23, 2022

(54) DATA RECOMMENDATION METHOD AND APPARATUS, COMPUTER DEVICE, AND STORAGE MEDIUM

(71) Applicant: Tencent Technology (Shenzhen) Company Limited, Shenzhen (CN)

(72) Inventors: Jiandong LU, Shenzhen (CN); Yanbing YU, Shenzhen (CN); Faxi ZHANG, Shenzhen (CN); Quan CHEN, Shenzhen (CN); Hui LI, Shenzhen (CN); Sansi YU, Shenzhen (CN); Congjie CHEN, Shenzhen (CN); Bangliu LUO, Shenzhen (CN); Yusen LIANG, Shenzhen (CN)

(73) Assignee: Tencent Technology (Shenzhen) Company Limited, Shenzhen (CN)

(21) Appl. No.: 17/690,688

(22) Filed: Mar. 9, 2022

Related U.S. Application Data
(63) Continuation of application No. PCT/CN2020/126061, filed on Nov. 3, 2020.

(30) Foreign Application Priority Data
Mar. 2, 2020 (CN) 202010137638.5

(51) Int. Cl. G06Q 30/02; G10L 15/26; G06F 40/40; G06F 16/483

(52) U.S. Cl. CPC G06Q 30/0255; G06F 16/483; G06F 40/40; G10L 15/26

(57) ABSTRACT

A data recommendation method is described. A first label set corresponding to multimedia data can be acquired. At least one second label set each corresponding to one of at least one to-be-recommended data can be acquired. Each second label set can include at least one label each representing a content attribute of the respective to-be-recommended data. A set similarity between the first label set and each of the at least one second label set can be determined according to label positions in the label tree. Target recommendation data matched with the multimedia data can be determined from the to-be-recommended data set according to the set similarity between the first label set and each of the at least one second label set.

### RELATED APPLICATION

This application is a continuation of International Application No. PCT/CN PCT/CN2020/126061, filed on Nov. 3, 2020, which claims priority to Chinese Patent Application No. 202010137638.5, filed on Mar. 2, 2020. The entire disclosures of the prior applications are hereby incorporated by reference in their entirety.

### FIELD OF THE TECHNOLOGY

This application relates to the field of Internet technologies, including a data recommendation method and apparatus, a computer device, and a storage medium.

### BACKGROUND OF THE DISCLOSURE

With the development of data digitalization, the data volume has increased rapidly, and users have viewed multimedia information with information application software more and more frequently. When a user views multimedia information, the information application software may recommend information of interest to the user. For example, when the user plays a short news video with the information application software, a service or product of interest may be recommended to the user while playing the short news video.

### SUMMARY

Aspects of the disclosure provide a data recommendation method. A first label set corresponding to multimedia data'can be acquired. The first label set can include at least one label each representing a content attribute of the multimedia data. A to-be-recommended data set including at least one to-be-recommended data and at least one second label set each corresponding to one of the at least one to-be-recommended data in the to-be-recommended data set can be acquired. Each second label set can include at least one label each representing a content attribute of the respective to-be-recommended data. A label tree can be acquired. The label tree can include a plurality of labels in a tree-structured hierarchical relationship. The labels in the label tree can include labels corresponding to the at least one label in the first label set and the at least one label in the at least one second label set. A set similarity between the first label set and each of the at least one second label set can be determined according to label positions of the at least one label in the first label set in the label tree and label positions of the at least one label in each of the at least one second label set in the label tree. Target recommendation data matched with the multimedia data can be determined from the to-be-recommended data set according to the set similarity between the first label set and each of the at least one second label set. The target recommendation data can be recommended to a target user for displaying the target recommendation data on a displaying interface.

Aspects of the disclosure provide a data recommendation apparatus. The apparatus can be configured to acquire a first label set corresponding to multimedia data. The first label set can include at least one label each representing a content attribute of the multimedia data. A to-be-recommended data set including at least one to-be-recommended data and at least one second label set each corresponding to one of the at least one to-be-recommended data in the to-be-recommended data set can be acquired. Each second label set can include at least one label each representing a content attribute of the respective to-be-recommended data. A label tree can be acquired. The label tree can include a plurality of labels in a tree-structured hierarchical relationship. The labels in the label tree can include labels corresponding to the at least one label in the first label set and the at least one label in the at least one second label set. A set similarity between the first label set and each of the at least one second label set can be determined according to label positions of the at least one label in the first label set in the label tree and label positions of the at least one label in each of the at least one second label set in the label tree. Target recommendation data matched with the multimedia data can be determined from the to-be-recommended data set according to the set similarity between the first label set and each of the at least one second label set. The target recommendation data can be recommended to a target user for displaying the target recommendation data on a displaying interface.

Aspects of the disclosure can provide a non-transitory computer-readable storage medium storing instructions which when executed by at least one processor cause the at least one processor to perform the data recommendation method.

### BRIEF DESCRIPTION OF THE DRAWINGS

To describe the technical solutions in the embodiments of this application, the following briefly introduces the accompanying drawings for describing the embodiments. The accompanying drawings in the following description show merely some embodiments of this application, and a person of ordinary skill in the art may still derive other accompanying drawings from these accompanying drawings.

FIG. 1 is a diagram of a network architecture according to an embodiment of this application.

FIGS. 2a and 2b are schematic diagrams of a data recommendation scene according to an embodiment of this application.

FIG. 3 is a flowchart of a data recommendation method according to an embodiment of this application.

FIG. 4 is a schematic diagram of a label tree according to an embodiment of this application.

FIG. 5 is a schematic diagram of determining a set similarity according to an embodiment of this application.

FIG. 6 is a structural schematic diagram of a data recommendation system according to an embodiment of this application.

FIGS. 7a and 7b are schematic diagrams of a data recommendation scene according to an embodiment of this application.

FIG. 8 is a structural schematic diagram of a data recommendation apparatus according to an embodiment of this application.

FIG. 9 is a structural schematic diagram of a computer device according to an embodiment of this application.

### DESCRIPTION OF EMBODIMENTS

The technical solutions in the embodiments of this application are described below with reference to the accompanying drawings in the embodiments of this application. The described embodiments are merely some rather than all of the embodiments of this application. All other embodiments obtained by a person of ordinary skill in the art based on the embodiments of this application shall fall within the protection scope of this application.

Artificial intelligence (AI) is a theory, a method, a technology, and an application system that use a digital computer or a machine controlled by the digital computer to simulate, extend, and expand human intelligence, perceive an environment, acquire knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study the design principles and implementation methods of various intelligent machines to enable the machines to have the functions of perception, reasoning, and decision-making.

Artificial intelligence technology is a comprehensive discipline, and relates to a wide range of fields including both hardware-level technologies and software-level technologies. The primary artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include several major directions such as computer vision technology, speech processing technology, natural language processing technology, and machine learning/deep learning.

The solutions provided in the embodiments of this application relate to computer vision (CV) technology, speech technology, and natural language processing (NLP) that belong to the field of artificial intelligence.

Computer vision is a science that studies how to use a machine to “see”, and furthermore, refers to using a camera and a computer to replace human eyes for performing machine vision, such as recognition, tracking, and measurement, on a target, and further perform graphic processing, so that the computer processes the target into an image more suitable for human eyes to observe, or an image transmitted to an instrument for detection. As a scientific discipline, computer vision studies related theories and technologies and attempts to establish an artificial intelligence system that can acquire information from images or multidimensional data. Computer vision technology generally includes technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, synchronous positioning, and map construction, and further include biological feature recognition technologies such as common face recognition and fingerprint recognition.

Key technologies of speech technology include automatic speech recognition (ASR) technology, text-to-speech (TTS) technology, and voiceprint recognition technology. To make a computer capable of listening, seeing, speaking, and feeling is the future development direction of human-computer interaction, and speech has become one of the most promising human-computer interaction methods in the future.

The natural language processing is an important direction in the fields of computer science and artificial intelligence. It studies various theories and methods for implementing effective communication between humans and computers through natural languages. The natural language processing is a science that integrates linguistics, computer science and mathematics. Therefore, studies in this field relate to natural languages, that is, languages used by people in daily life, and the natural language processing is closely related to linguistic studies.

Generally speaking, an advertisement of a commodity (service or product) may be randomly selected from massive commodity data, and the randomly selected advertisement of the commodity is recommended to a user when the user views multimedia data (video, webpage, and the like). However, the user tends to select multimedia data of interest for viewing, and when the advertisement of the commodity is randomly recommended to the user, the recommended item tends to be unrelated to the multimedia data viewed by the user. As a result, the commodity recommendation accuracy is reduced.

In view of this, the embodiments of this application provide a data (advertisement information) recommendation method and apparatus, a computer device, and a storage medium to improve the accuracy of data recommendation.

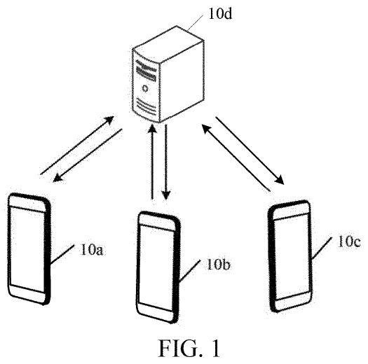

Referring to FIG. 1, a diagram of a network architecture according to an embodiment of this application is shown. The network architecture may include a server 10d and multiple terminal devices, including a terminal device 10a, 10b, and 10c. The server 10d may perform data transmission with each terminal device through a network.

Taking the terminal device 10a as an example, when a user views multimedia data through an information application in the terminal device 10a, the terminal device 10a may acquire the multimedia data currently viewed by the user and send the acquired multimedia data to the server 10d. After receiving the multimedia data sent by the terminal device 10a, the server 10d may extract a label(s) for representing a content attribute(s) of the multimedia data through a network model including, for example, an image recognition model, a text recognition model, a text conversion model, and the like. The image recognition module may be used for recognizing an object in image data. The text recognition model may be used for extracting a content attribute in text data. The text conversion module may be used for converting audio data into text data. The server 10d may acquire a to-be-recommended data set corresponding to the multimedia data according to the extracted label(s), and further extract a label(s) corresponding to each piece of to-be-recommended data in the to-be-recommended data set through the network model. Label data is acquired to determine a similarity between the multimedia data and each piece of to-be-recommended data in the to-be-recommended data set according to, for example, a position of the label corresponding to the multimedia data in a label tree and a position of the label corresponding to the to-be-recommended data in the label tree. Furthermore, target recommendation data matched with the multimedia data may be determined from the to-be-recommended data set according to the similarity. In another example, the multimedia data viewed by the user may be received from the server 10d.

Of course, if the terminal device 10a integrates image recognition, text recognition, text conversion and other functions, the network model in the terminal device 10a may directly extract the label(s) in the multimedia data and the label(s) in each piece of to-be-recommended data in the to-be-recommended data set, calculate the similarity between the multimedia data and the to-be-recommended data according to the labels, and further determine the target recommendation data for the user according to the similarities. It may be understood that the data recommendation solution disclosed in the embodiments of this application may be performed by a computer program (including a program code) on a computer device. For example, the data recommendation solution is performed by application software. A client of the application software may detect a behavior (such as playing a video and clicking to read news information) of a user for multimedia data. A back-end server of the application software determines target recommendation data matched with the multimedia data. Some descriptions use a terminal device as an example to illustrate how to determine target recommendation data corresponding to multimedia data.

The terminal device 10a, the terminal device 10b, the terminal device 10c may each include a mobile phone, a tablet computer, a notebook computer, a palm computer, a mobile Internet device (MID), a wearable device (such as a smart watch and a smart band), and the like.

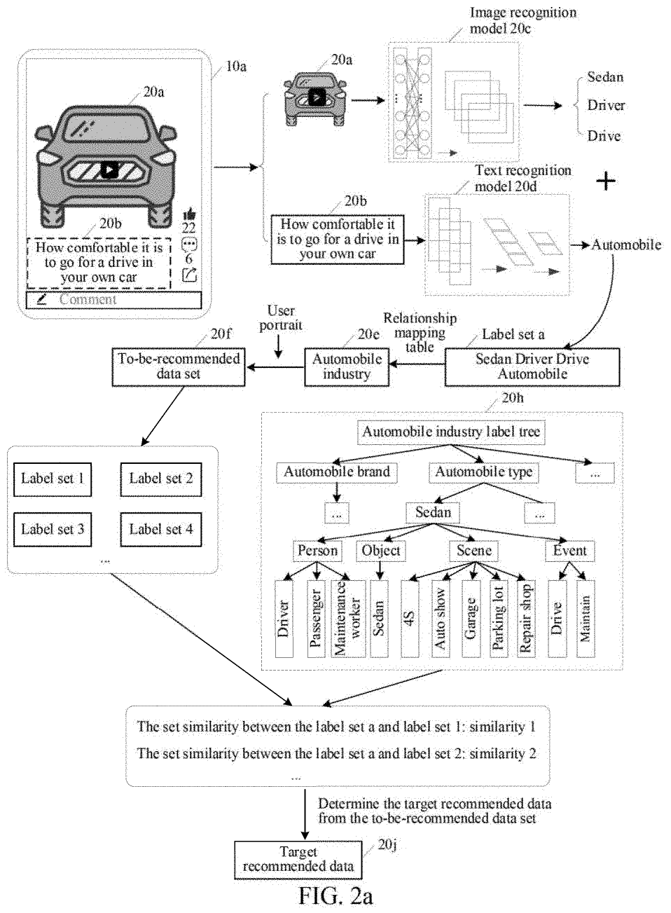

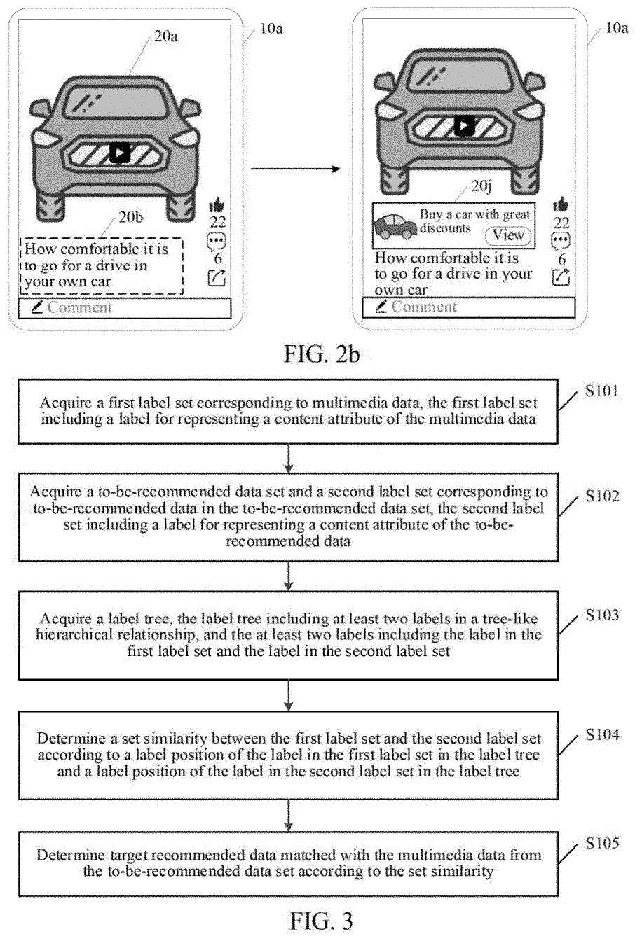

Referring to FIGS. 2a and 2b, schematic diagrams of a data recommendation scene according to an embodiment of this application are shown. As shown in FIG. 2a, information application software (the information application software may handle text information, image information, video information, and the like) may be installed in a terminal device 10a. When a user views video information through the terminal device 10a (for example, the user selects to play a video 20a), the terminal device 10a may acquire the video 20a currently played by the user and a title 20b corresponding to the video 20a. It may be understood that the currently played video 20a, the title 20b corresponding to the video 20a and behavioral statistical data corresponding to the video 20a (such as comments and likes corresponding to the video 20a) may be displayed on a playing interface of the terminal device 10a when the user plays the video 20a through the terminal device 10a.

In order to obtain a label(s) for representing a content attribute(s) of the video 20a, the terminal device 10a may separate audio and animation in the video 20a and further frame the animation in the video 20a to obtain multiple frames of images corresponding to the video 20a. The terminal device 10a may perform speech calculation on the audio in the video 20a to convert the audio in the video 20a into a text. In an example, if the video 20a does not include the audio, the terminal device 10a needs not to perform audio and animation separation, audio conversion and other operations on the video 20a.

In an example, both the text converted from the audio and the title 20b are Chinese texts without separators for separating words therein. Therefore, the terminal device 10a further needs to perform word segmentation on the text converted from the audio and the title 20b by use of a Chinese word segmentation algorithm to obtain character sets respectively corresponding to the text converted from the audio and the title 20b. For example, the title 20b is “ [symbol] , [symbol] ” (“How comfortable it is to go for a drive in your own car”), and a character set obtained by performing word segmentation on the title 20b by use of the Chinese word segmentation algorithm includes “ [symbol] ” (“in”), “ [symbol] ” (“own”), “ [symbol] ” (“car”), “ [symbol] ” (“go for a drive”), “ [symbol] ” (“really”), “ [symbol] ” (“is”), and “ [symbol] ” (“comfortable”). The Chinese word segmentation algorithm may be a dictionary-based word segmentation algorithm, a statistics-based word segmentation algorithm, etc. No limits are made herein. In another example, the texts are in a language other than Chinese. Suitable techniques can be employed to process the texts.

Since the character set corresponding to the title 20b is described in a natural language, the terminal device 10a may convert, based on word embedding, each character in the character set into a word vector understandable for a computer, i.e., a numerical representation of the character. Each character is converted into a vector representation of a fixed length. In the embodiments of this application, the terminal device 10a may concatenate the word vector corresponding to each character in the character set into a text matrix corresponding to the title 20b. A concatenation order of the word vectors may be determined according to positions of the characters in the title 20b.

In an example, the terminal device 10a may acquire an image recognition model 20c and a text recognition model 20d. The image recognition model 20c may extract a feature(s) of an object(s) in image data and recognize a label(s) corresponding to the recognized object(s). The text recognition model 20d may extract a semantic feature(s) in text data and recognize a label(s) corresponding to the text data. The image recognition model includes, but not limited to, a convolutional neural network model and a deep neural network model. The text recognition model includes, but not limited to, a convolutional neural network model, a recurrent neural network model, a deep neural network model, and the like.

In an example, the terminal device 10a may input the multiple frames of images corresponding to the video 20a to the image recognition model 20c, extract a content feature(s) in each image according to the image recognition model 20c, recognize the extracted content feature(s), determine matching probability values between the content feature(s) and multiple attribute labels in the image recognition model 20c, and determine the label(s) that the content feature(s) belongs to according to the matching probability values. The labels acquired by the terminal device 10a from the multiple frames of images include sedan, driver, and drive, for example. The title 20b and the text converted from the audio in the video 20a are input to the text recognition model 20d, respectively. Label “automobile” corresponding to the video 20a may be extracted from the title 20b and the text converted from the audio according to the text recognition model 20d. Of course, a matching probability value corresponding to label “automobile” may be determined in the text recognition model 20d. The terminal device 10a may determine the labels extracted from the image recognition model 20c and the label extracted from the text recognition model 20d as label set a corresponding to the video 20a. Label set a may include sedan, driver, drive, and automobile. In such case, label set a may be referred to as a content label portrait corresponding to the video 20a.

In an example, the terminal device 10a may acquire (determine) a relationship mapping table. The terminal device 10a may acquire (determined) from the relationship mapping table that a recommended industry corresponding to label set a is an automobile industry 20e. The terminal device 10a may acquire a user portrait corresponding to the above-mentioned user (i.e., the user playing the video 10a through the terminal device 10a), search a recommendation database according to label set a and the user portrait, further find service data matched with the user portrait and belonging to the automobile industry 20e from the recommendation database as to-be-recommended data corresponding to the video 20a, and add the to-be-recommended data to a to-be-recommended data set 20f. The relationship mapping table may be used for storing mapping relationships between multimedia data labels and recommended industries (also referred to as recommendation types). The relationship mapping table may be pre-constructed. The pre-constructed relationship mapping table is locally stored. Of course, the pre-constructed relationship mapping table may be stored in a cloud server, a cloud storage space, a server, and the like. The user portrait may be represented as a labeled user model abstracted according to information such as an attribute(s) of the user, a user preference, a living habit, and a user behavior. The recommendation database includes all service data (such as advertisement data) for a recommendation.

In an example, the terminal device 10a may acquire a label set corresponding to each piece of to-be-recommended data in the to-be-recommended data set 20f. That is, each piece of to-be-recommended data in the to-be-recommended data set 20f corresponds to a label set. For example, when the to-be-recommended data set 20f includes data such as to-be-recommended data 1, to-be-recommended data 2, to-be-recommended data 3 and to-be-recommended data 4, the terminal device 10a may acquire label set 1 corresponding to to-be-recommended data 1, label set 2 corresponding to to-be-recommended data 2, label set 3 corresponding to to-be-recommended data 3, and label set 4 corresponding to to-be-recommended data 4.

It may be understood that each piece of service data in the recommendation database may include image data and a title. The terminal device 10a may extract corresponding labels in advance from each piece of service data according to the image recognition model 20c and the text recognition model 20d to obtain a label set corresponding to each piece of service data, and store the service data and the label set corresponding to the service data. The terminal device 10a, after determining the to-be-recommended data set 20f corresponding to the video 20a, may directly acquire the label set corresponding to each piece of to-be-recommended data in the to-be-recommended data set 20f from all the stored label set/sets. Of course, when new service data is added to the recommendation database, the terminal device 10a may extract corresponding labels from the newly added service data according to the image recognition model 20c and the text recognition model 20d to obtain and store a label set corresponding to the newly added service data. When a certain piece of service data is deleted from the recommendation database, label data corresponding to the service data may be deleted from the stored label set. In other words, the stored label set may be updated in real time according to the service data in the recommendation database.

In an example, the terminal device 10a may acquire a pre-constructed automobile industry label tree 20h constructed by summarizing labels in the automobile industry according to at least four dimensions (person, object, event, scene). The automobile industry label tree 20h includes at least two labels of a tree-like structure, including labels in the label set/sets corresponding to the to-be-recommended data. The automobile industry label tree 20h may include automobile brand, automobile type, automobile service, etc. The automobile type may include sedan, off-road vehicle, sports car, multi-purpose vehicle, minibus, etc. According to the at least four dimensions, person in the sedan type may include driver, passenger, maintenance worker, etc., object in the sedan type is sedan, scene in the sedan type may include automobile sales service shop (4S), auto show, garage, parking lot, repair shop, etc., and event in the sedan type may include drive, maintain, etc. The terminal device 10a may acquire a vector similarity between every two adjacent labels in the automobile industry label tree 20h, and determine the vector similarity between two adjacent labels as an edge weight between the two adjacent labels. The vector similarity between two adjacent labels in the automobile industry label tree 20h may be determined by converting the labels into vectors and calculating a distance between the two vectors.

In an example, the terminal device 10a may determine a label path, between a label in label set a and a label in the label set corresponding to the to-be-recommended data, in the automobile industry label tree 20h according to a label position of the label in label set a in the automobile industry label tree 20h and a label position of the label in the label set corresponding to the to-be-recommended data in the automobile industry label tree 20h, map an edge weight in the label path into a numerical value through a conversion function, and further multiply-accumulate the numerical value and confidences (the confidence here refers to a matching probability value when the image recognition model 20c or the text recognition model 20d predicts the corresponding label) respectively corresponding to the two labels to obtain a unit similarity between the two labels. For example, a unit similarity between label 1 in label set a and label 2 in label set 1 is calculated through the following process: a label path between label 1 and label 2 is determined in the automobile industry label tree 20h, an edge weight in the label path is mapped into a numerical value through a conversion function, and the numerical value, a confidence corresponding to label 1 and a confidence corresponding to label 2 are multiplied-accumulated to obtain the unit similarity between label 1 and label 2. A set similarity between label set a and the label set corresponding to the to-be-recommended data may be determined according to the unit similarity. For example, a set similarity between label set a and label set 1 is similarity 1, and a set similarity between label set a and label set 2 is similarity 2. The terminal device 10a may sequence the to-be-recommended data in the to-be-recommended data set 20f according to an order from high to low set similarities, and determine target recommendation data 20j matched with the video 20a from the sequenced to-be-recommended data set 20f.

As shown in FIG. 2b, the terminal device 10a, after determining the target recommendation data 20j corresponding to the video 20a, may display the target recommendation data 20j on a playing interface of the video 20a. The user may click the target recommendation data 20j on the playing interface of the video 20a to view detailed information of the target recommendation data 20j. Of course, the terminal device 10a may select first K (K is a positive integer more than or equal to 1 here) pieces of to-be-recommended data from the sequenced to-be-recommended data set 20f as K piece/pieces of target recommendation data matched with the video 20a. The terminal device 10a may sequentially display the K piece/pieces of target recommendation data on the playing interface of the video 20a. For example, display time corresponding to each piece of target recommendation data is equally allocated according to a total length of the video 20a, and the K piece/pieces of target recommendation data are displayed on the playing interface according to a sequencing order. Alternatively, a display order and display time corresponding to the K piece/pieces of target recommendation data are determined according to a currently played content of the video 20a. No specific limits are made herein.

Referring to FIG. 3, a flowchart of a data recommendation method according to an embodiment of this application is shown. As shown in FIG. 3, the data recommendation method may include the following steps.

In Step S101, a first label set corresponding to multimedia data can be acquired (determined), the first label set including a label(s) for representing a content attribute(s) of the multimedia data.

In an example, when a user views multimedia data (such as the video 20a in the embodiment corresponding to FIG. 2a) through an information application in a terminal device, the terminal device (such as the terminal device 10a in the embodiment corresponding to FIG. 2a) may acquire the multimedia data currently viewed by the user, input the multimedia data to a network model, extract a content feature from the multimedia data through the network model, recognize the content feature to acquire a label that the content feature belongs to, and add the recognized label to a first label set. In other words, the first label set includes a label for representing a content attribute of the multimedia data. The multimedia data includes at least one data type of a video, an image, a text and an audio. For example, the multimedia data may be video data (such as short news video), or image data (such as a propaganda picture), or text data (such as an electronic book and an article).

In an example, when the multimedia data includes video data, audio data (i.e., a speech in the video data) and text data (i.e., a title corresponding to the video data), the terminal device, after acquiring the multimedia data, may frame the video data in the multimedia data to obtain at least two pieces of image data corresponding to the video data, input the at least two pieces of image data to an image recognition model (such as the image recognition model 20c in the embodiment corresponding to FIG. 2a), and acquire labels respectively corresponding to the at least two pieces of image data in the image recognition model. The terminal device may input the text data in the video data to a text recognition model and acquire a label corresponding to the text data in the text recognition model. The labels respectively corresponding to the at least two pieces of image data and the label corresponding to the text data are added to the first label set. For speech data in the video, the terminal device may convert the speech data into a text through a speech recognition technology, input the text obtained by conversion to the text recognition model, acquire a label corresponding to the text obtained by conversion through the text recognition model, and add the label corresponding to the text obtained by conversion to the first label set.

In an example, the video data includes multiple continuous frames of images. The video data may be framed according to the number of frames transmitted per second in the video data to obtain the at least two pieces of image data corresponding to the video data. In the embodiments of this application, the terminal device may extract part of images from the video data, namely extracting a frame of image from the video data at certain intervals, for example, extracting a frame of image every 0.5 seconds, to further obtain the at least two pieces of image data corresponding to the video data.

In the embodiments of this application, a label extraction process for the at least two pieces of image data is specifically described taking the condition that the image recognition model is a convolutional neural network as an example: the at least two pieces of image data are input to the convolutional neural network respectively, a content feature is acquired from each piece of image data according to a convolutional layer in the convolutional neural network, the content feature is further recognized through a classifier in the convolutional neural network, matching probability values (also referred to as confidences) between the content feature and multiple attribute features in the classifier are determined, and a label that the attribute feature corresponding to the maximum matching probability value belongs to is determined as the label corresponding to the image data. The convolutional neural network may include multiple convolutional layers and multiple pooling layers. The convolutional layers are alternately connected with the pooling layers. The content feature may be extracted from the image data by convolution operations of the convolutional layers and pooling operations of the pooling layers. The convolutional layer corresponds to at least one kernel (also referred to as a filter or receptive field). The convolution operation refers to performing a matrix multiplication operation on the kernel and sub-matrices at different positions of an input matrix. A row count Hₒᵤₜ and column count Wₒᵤₜ of an output matrix after the convolution operation are determined by a size of the input matrix, a size of the kernel, a stride and a boundary padding, namely Hₒᵤₜ=(Hᵢₙ−Hₖₑᵣₙₑₗ+2*padding)/stride+1, and Wₒᵤₜ=(Wᵢₙ−Wₖₑᵣₙₑₗ+2*padding)/stride+1. Hᵢₙ and Hₖₑᵣₙₑₗ represent a row count of the input matrix and a row count of the kernel respectively. Wᵢₙ and Wₖₑᵣₙₑₗ represent a column count of the input matrix and a column count of the kernel respectively. A pooling operation is performed on the output matrix of the convolutional layer according to the pooling layer. The pooling operation refers to performing aggregation statistics on the extracted output matrix. The pooling operation may include an average pooling operation and a max-pooling operation. The average pooling operation refers to calculating an average value in each row (or column) of the output matrix to represent this row (or column). The max-pooling operation refers to extracting a maximum value from each row (or column) of the output matrix to represent this row (or column).

In an example, for the audio data in the video data, silences may be removed from the audio data at first. Audio framing is performed on the audio data from which the silences are removed. That is, the audio data from which the silences are removed is segmented into audio frames by use of a moving window function. A length of each audio frame may be a fixed value (such as 25 milliseconds). A feature in each audio frame may further be extracted. That is, each audio frame is converted into a multidimensional vector including sound information. Afterwards, the multidimensional vector corresponding to each audio frame may be decoded to obtain a text corresponding to the audio data.

In an example, the terminal device may segment the text data (including the title of the video data and the text converted from the audio data) in the multimedia data into multiple unit characters and convert each unit character into a unit word vector. The terminal device may label a word sequence corresponding to the text data based on a hidden Markov model (HMM) and further segment the text data according to the labeled sequence to obtain the multiple unit characters. The HMM may be described by a quintet of an observation sequence, a hidden sequence, a hidden state start probability (i.e., a start probability), a transition probability between hidden states (i.e., a transition probability), and a probability that the hidden state is represented as an observed value (i.e., an emission probability). The start probability, the transition probability and the emission probability may be obtained by large-scale corpus statistics. A probability of a next hidden state is calculated from an initial hidden state, transition probabilities of all subsequent hidden states are sequentially calculated, and a hidden state sequence corresponding to maximum probabilities is finally determined as a hidden sequence, i.e., a sequence labeling result. For example, when the text data is “ [symbol] ” (“We are Chinese”), a sequence labeling result BESBME (B represents that the character is a start character of the phrase, M represents that the character is a middle character of the phrase, E represents that the character is an end character of the phrase, and S represents that a single character forms a phrase) may be obtained based on the HMM. Since a sentence ends with E or S only, a word segmentation mode is BE/S/BME, further, a word segmentation mode of the text data “ [symbol] ” (“We are Chinese”) is obtained: [symbol] (We/are/Chinese), and the obtained multiple unit characters are “ [symbol] ” (“we”), “ [symbol] ” (“are”), and “ [symbol] ” (“Chinese”) respectively. Of course, the text data may be described in English or other languages. In such case, a word sequence corresponding to the text data uses spaces as natural delimiters between words, and thus may be segmented directly.

Afterwards, in an example, the terminal device may find a one-hot code corresponding to each unit character from a character word bag. The character word bag includes a series of unit characters in the text data and a one-hot code corresponding to each unit character. The one-hot code is a vector including only one 1 and all other 0s. As in the above-mentioned example, the multiple unit characters corresponding to the text data are “ [symbol] ” (“we”), “ [symbol] ” (“are”), and “ [symbol] ” (“Chinese”) respectively. When the character word bag includes the three unit characters only, a one-hot code of the unit character “ [symbol] ” (“we”) in the character word bag may be represented as [1,0,0], a one-hot code of unit character “ [symbol] ” (“are”) in the character word bag may be represented as [0,1,0], and a one-hot code of unit character “ [symbol] ” (“Chinese”) in the character word bag may be represented as [0,0,1]. It can be seen that, if a one-hot code is directly used as a unit word vector representation of a unit character, it is impossible to learn a relationship (such as positional and semantic relationships in the text data) between each unit character, and when the character word bag includes many unit characters, a dimension of a unit word vector represented by a one-hot code may be very high. Therefore, the terminal device may acquire a unit word vector conversion model to convert a high-dimensional one-hot code into a low-dimensional word vector. Based on a weight matrix corresponding to a hidden layer in the unit word vector conversion model, an input first initial vector is multiplied by the weight matrix to obtain a vector as a unit word vector corresponding to the unit character. The unit word vector conversion model may be obtained by training according to word2vec (word vector conversion model) and GloVe (word embedding tool). A row count of the weight matrix is equal to a dimension of the one-hot code. A column count of the weight matrix is equal to a dimension of the unit word vector. For example, when a size of the one-hot code corresponding to the unit character is 1×100 and a size of the weight matrix is 100×10, a size of the unit word vector is 1×10.

The terminal device may input the word vector corresponding to each unit character in the text data to the text recognition model (such as the text recognition model 20d in the embodiment corresponding to FIG. 2a), extract a semantic feature from the input word vector according to the text recognition model, and recognize the semantic feature to obtain a label that the semantic feature belongs to, i.e., the label corresponding to the text data. Of course, a matching probability value, also referred to as a confidence, corresponding to the label that the text data belongs to may be acquired through the text recognition model.

The terminal device may add the labels respectively corresponding to the at least two pieces of image data and the label corresponding to the text data to the first label set. The first label set is a label set corresponding to the multimedia data.

In Step S102, a to-be-recommended data set and a second label set corresponding to each to-be-recommended data in the to-be-recommended data set can be acquired (determined), the second label set including a label(s) for representing a content attribute(s) of the to-be-recommended data.

In an example, the terminal device may acquire a target user corresponding to the multimedia data and a user portrait corresponding to the target user, perform data searching in a recommendation database according to the user portrait and a recommendation type, determine found service data as to-be-recommended data, add the to-be-recommended data to a to-be-recommended data set, acquire a label corresponding to the to-be-recommended data from a recommendation data label library, and add the label to a second label set. The recommendation database includes all service data for recommendation. The recommendation data label library is used for storing labels corresponding to service data in the recommendation database. The service data may refer to commodity data, electronic book, music data, and the like, for recommendation. The recommendation type may refer to an industry type corresponding to the service data, such as an educational industry, an automobile industry and a clothing industry. The user portrait may be determined based on information such as a user preference and a user behavior. For example, when the service data is commodity data, the user portrait may be determined based on a user preference and information about what the user bought, browsed and paid attention to in an e-commerce platform.

It is to be understood that the terminal device may pre-construct a relationship mapping table between all multimedia data labels and recommendation types. After the first label set corresponding to the multimedia data is acquired, a recommendation type corresponding to the first label set may be acquired from the relationship mapping table according to the first label set, service data matched with the user portrait and belonging to the recommendation type may further be acquired from the recommendation database as to-be-recommended data, and all the acquired to-be-recommended data forms a to-be-recommended data set. After the to-be-recommended data set is acquired, labels corresponding to the to-be-recommended data in the to-be-recommended data set may be directly acquired from the recommendation data label library so as to obtain a second label set corresponding to each piece of to-be-recommended data. For example, if the first label set includes label “automobile”, the terminal device may map the first label set to the automobile industry according to the relationship mapping table. That is, the recommendation type corresponding to the first label set is the automobile industry. The recommendation database is searched according to the automobile industry and the user portrait. Service data matched with the user portrait and belonging to the “automobile industry” in the recommendation database forms a to-be-recommended data set. In such case, the service data in the to-be-recommended data set is to-be-recommended data. Furthermore, a second label set corresponding to each to-be-recommended data may be acquired from the recommendation data label library.

In an example, in order to improve the data recommendation efficiency, the terminal device may extract the labels corresponding to the service data in the recommendation database in advance and store the label corresponding to each piece of service data in the recommendation data label library. The recommendation data label library may be stored in the terminal device, or in a database, or in a device for data recommendation such as a server, a cloud server, a cloud storage space and a storage space. The service data may include at least one data type of an audio, an image and a text. For image data in the service data, the image data may be input to the image recognition model, and a corresponding label is extracted from the image data through the image recognition model. For text data (which may include a title of the image data, and if the service includes audio data, the audio data may be converted into text data) in the service data, the text data may be input to the text recognition model, and a corresponding label is extracted from the text data through the text recognition model. The labels extracted by the image recognition model and the text recognition model from the same service data are stored. For a process of converting the audio data into the text data and processes of extracting the labels by the image recognition model and the text recognition model, reference may be made to the descriptions in step S101.

In the embodiments of this application, when new service data is added to the recommendation database, the terminal device may acquire a label(s) corresponding to the new service data and store the label corresponding to the new service data in the recommendation data label library. When a certain piece of service data is deleted from the recommendation database (for example, the service data has been removed from the e-commerce platform), the terminal device may delete a label corresponding to the service data from the recommendation data label library.

In an example, the terminal device may extract the second label set corresponding to each piece of to-be-recommended data in the to-be-recommended data set through the image recognition model and the text recognition model after acquiring the to-be-recommended data set corresponding to the multimedia data. That is, the terminal device may extract labels corresponding to the to-be-recommended data in real time.

In Step S103, a label tree can be acquired, the label tree including at least two labels in a tree-like hierarchical relationship, and the at least two labels including (or corresponding to) the label in the first label set and the label in the second label set.

In an example, the terminal device may acquire the label tree (such as the automobile industry label tree 20h in the embodiment corresponding to FIG. 2a) after acquiring the first label set corresponding to the multimedia data and the second label set corresponding to the to-be-recommended data in the to-be-recommended data set. The label tree may include at least two labels in a tree-like hierarchical relationship. The at least two labels in the label tree may include the label in the first label set and the label in the second label set. In other words, the terminal device may represent the at least two labels in a tree-like structure. The tree-like structure has the characteristics of low data storage redundancy, high visualization and simple and efficient search traversing process. The label tree may refer to a label system including a plurality of service industries or a label system of a certain service industry.

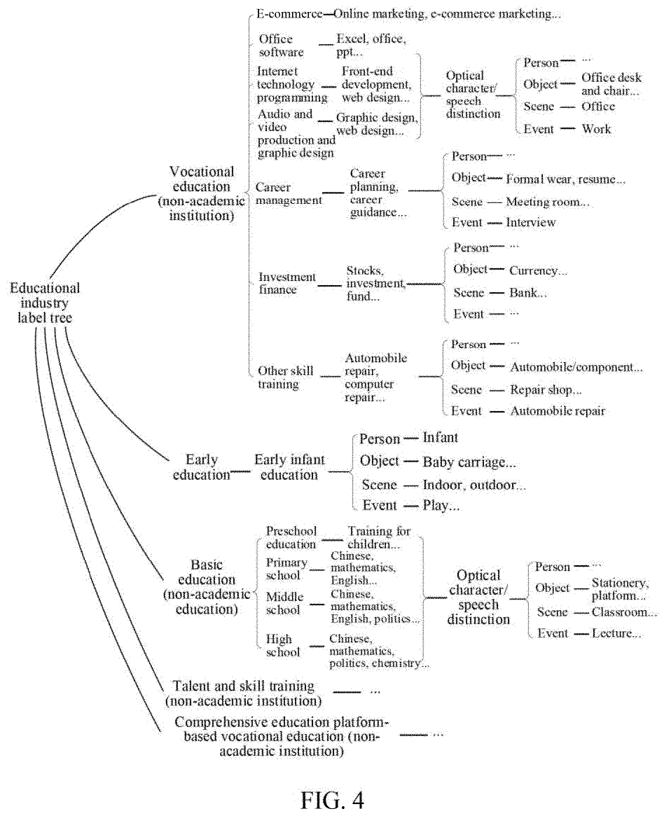

Referring to FIG. 4, a schematic diagram of a label tree according to an embodiment of this application is shown. As shown in. FIG. 4, descriptions are made taking a label tree of the educational industry as an example. Labels of the educational industry may be sorted according to at least four dimensions (person, object, event, scene) so as to obtain an educational industry label tree. The educational industry label tree may include parent node labels such as vocational education (non-academic institution), early education, basic education (non-academic education), talent and skill training (non-academic institution), academic education (academic institution), and comprehensive education platform-based vocational education (non-academic institution). Node label vocational education (non-academic institution) may include child node labels such as e-commerce, office software, Internet technology programming, audio and video production/graphic design, career management, investment finance, and other skill training. Each child node label may include labels of at least four dimensions of person, object, event, scene, etc. For example, node label career management may include labels such as career planning, career guidance, career skill, enterprise training, and entrepreneurial guidance. According to the at least four dimensions of person, object, event and scene; person corresponding to the labels such as career planning, career guidance, career skill, enterprise training and entrepreneurial guidance includes trainer, trainee, etc.; object may correspondingly include formal wear, resume, honer certificate, etc.; scene may correspondingly include meeting room, training room, etc.; and event may correspondingly include interview, etc. All the parent node labels in the educational industry label tree such as vocational education (non-academic institution), early education, basic education (non-academic education), talent and skill training (non-academic institution), academic education (academic institution) and comprehensive education platform-based vocational education (non-academic institution) may include labels of the at least four dimensions.

In an example, after the label tree is created, the label tree may be uploaded to a blockchain network through a client, and a blockchain node in the blockchain network packs the label tree into a block and writes the block in a blockchain. The terminal device may read the label tree from the blockchain. The label tree stored in the blockchain is tamper-proof. Therefore, the stability and the effectiveness of the label tree may be improved.

The blockchain is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, the information being used for verifying the validity of information of the data block (anti-counterfeiting) and generating a next data block. The blockchain may include a blockchain underlying platform, a platform product service layer, and an application service layer.

The blockchain underlying platform may include processing modules such as a user management module, a basic service module, a smart contract module, and an operation supervision module. The user management module is responsible for the identity information management of all blockchain participants, including the maintenance of public and private key generation (account management), key management, and maintenance of the correspondence between the user's real identity and the blockchain address (authority management), etc. The user management module supervises and audits certain real-identity transactions, and provides rule configuration for risk control (risk control audit) with authorization. The basic service module is deployed on all blockchain node devices, to verify the validity of a service request, and record a valid request on the storage after completing the consensus on the valid request. For a new service request, the basic service firstly adapts, analyzes and authenticates the interface (interface adaptation); then encrypts the service information by consensus algorithm (consensus management); completely and consistently transmits the service request to a shared ledger (network communication) after the encryption; and records and stores the service request. The smart contract module is responsible for contract registration and issuance as well as contract triggering and contract execution. Developers can define contract logic by a certain programming language, publish the defined contract logic on the blockchain (contract registration), call keys or other events to trigger execution according to the logic of contract terms, to complete the contract logic. The smart contract module further provides a function of contract upgrade and cancellation. The operation supervision module is mainly responsible for the deployment during the product release process, configuration modification, contract settings, cloud adaptation, and visual output of real-time status during product operation, such as alarms, supervising network conditions, supervising node device health status, etc.

The platform product service layer provides basic capabilities and an implementation framework of a typical application. Based on these basic capabilities, developers may superpose characteristics of services and complete blockchain implementation of service logic. The application service layer provides a blockchain solution-based application service for use by a service participant.

In Step S104, a set similarity between the first label set and the second label set can be determined according to a label position of the label in the first label set in the label tree and a label position of the label in the second label set in the label tree.

In an example, the terminal device may determine the set similarity between the first label set and the second label set according to the label position of the label in the first label set in the label tree and the label position of the label in the second label set in the label tree. For example, when the label tree is a label system including a plurality of service industries, the terminal device may extract the recommendation type corresponding to the first label set (or referred to as a service industry matched with the first label set) from the relationship mapping table, determine a sub label tree corresponding to the recommendation type from the label tree according to the recommendation type, and determine the set similarity between the first label set and the second label set according to a label position of the label in the first label set in the sub label tree and a label position of the label in the second label set in the sub label tree. For example, if the label tree includes labels of multiple industries such as the automobile industry, the educational industry, the clothing industry and the beverage industry, the terminal device, when acquiring from the relationship mapping table that the recommendation type matched with the first label set is the automobile industry, may determine a sub label tree corresponding to the automobile industry from the label tree, all labels in the sub label tree being label elements in the automobile industry.

A process of calculating the set similarity between the first label set and the second label set is described below.

In an example, the terminal device may acquire the labels in the label tree, generate a word vector corresponding to each label in the label tree, further acquire a vector similarity between the word vectors corresponding to two adjacent labels in the label tree, and determine the vector similarity as an edge weight between the two adjacent labels in the label tree. In other words, since the label in the label tree is a text character string described in a natural language, the terminal device may convert all the labels in the label tree into the corresponding word vectors based on word embedding, and calculate the vector similarities between the word vectors to obtain the edge weights between every two adjacent labels in the label tree. The edge weight between every two adjacent labels in the label tree is fixed. For example, when the label tree includes label automobile and label sports car, label automobile may be mapped into word vector v1, label sports car may be mapped into word vector v2, and a vector similarity between word vector v1 and word vector v2 may be calculated to obtain an edge weight between label automobile and label sports car. Methods for calculating the vector similarity include, but not limited to, Manhattan distance, Euclidean distance, cosine similarity, and Mahalanobis distance.

In an example, the label tree may be represented as T_{AC}={(tₓ,wtₓ,Eᵣ^{x})|x, r=1, 2, . . . , X, Eᵣ^{x}∈edge(tₓ)}, where T_{AC} represents the label tree, X may represent the total number of the node labels in the label tree T_{AC}, tₓ may represent any node label in the label tree T_{AC}, wtₓ may represent an importance weight corresponding to node label tₓ, and Eᵣ^{x} may represent an edge weight between node label tₓ and node label tᵣ, node label tₓ and node label tᵣ being adjacent node labels in the label tree T_{AC}.

The first label set may be represented as CL={(cᵢ,wcᵢ)|=1, 2, . . . , n}, where CL represents the first label set corresponding to the multimedia data, n may represent the total number of labels in the first label set CL, cᵢ may represent any label in the first label set CL, and wcᵢ may represent a confidence corresponding to label cᵢ in the first label set CL.

The to-be-recommended data set may include K piece/pieces of to-be-recommended data. Each to-be-recommended data may correspond to a second label set. That is, the terminal device may acquire k second label set/sets, which may be represented as {Sₖ|k=1, 2, . . . ,}, k being a positive integer. The second label set Sₖ may be represented as Sₖ={tⱼ|tⱼ∈T_{AC}, j=1, 2, . . . , m}, where m may represent the total number of labels in the second label set Sₖ. Label tⱼ in the second label set Sₖ belongs to the label tree T_{AC}. Importance weights corresponding to the node labels in the label tree T_{AC} are correlated with confidences corresponding to the labels in the k second label set/sets. In other words, when the set similarity between the first label set CL and the second label set Sₖ is calculated, the importance weights of the node labels in the label tree T_{AC} are determined by the confidences corresponding to the labels in the second label set Sₖ. For example, the label tree T_{AC} includes six node labels (namely X=6), and the six node labels are label t₁, label t₂, label t₃, label t₄, label t₅ and label t₆, respectively. The second label set Sₖ includes three labels (namely m=3), and the three labels are label t₁, label t₃ and label t₅, respectively. When the set similarity between the first label set CL and the second label set Sₖ is calculated, importance weights respectively corresponding to label t₁, label t₃ and label t₅ in the label tree t_{AC} are confidences respectively corresponding to the three labels in the second label set Sₖ, and importance weights corresponding to label t₂, label t₄ and label t₆ in the label tree T_{AC} are 0. Therefore, when the set similarities between the first label set CL and different second label set/sets are calculated, for label cᵢ in the first label set CL and label tⱼ in the second label set Sₖ, if label cᵢ is the same as a certain node label in the label tree T_{AC}, a label path between label cᵢ and label tⱼ may be determined in the label tree T_{AC} according to a label position of label cᵢ in the label tree T_{AC} and a label position of label tⱼ in the label tree T_{AC}, and a unit similarity between label cᵢ and label tⱼ (i.e., a similarity between the two labels) may be obtained according to an edge weight in the label path, a confidence (also referred to as a first confidence for distinguishing from a confidence corresponding to label tⱼ) corresponding to label cᵢ and a confidence (also referred to as a second confidence) corresponding to label tⱼ. When label cₜ is the same as node label tₓ in the label tree T_{AC}, the unit similarity between label cᵢ and label tⱼ may be calculated through the following formula (1):

F(cᵢ,tⱼ)=max{wcᵢ·wtⱼ·f(L_{q}^{ij})|L_{q}^{ij}∈Lⱼⁱ}

L_{q}^{ij}={Dₓⁱ,E_{y}^{x},Eᵣ^{y}, . . . , Eⱼ^{z}}, q=1, 2, . . . , p (1)

F(cᵢ, tⱼ) may represent the unit similarity between label cᵢ and label tⱼ. Lⱼⁱ may represent a label path set between label cᵢ and label tⱼ in the label tree T_{AC}, the label path set Lⱼⁱ including p label paths. L_{q}^{ij} represents a qth label path between label cᵢ and label tⱼ, label path L_{q}^{ij} including an edge weight between label tⱼ and node label tₓ (i.e., a node label corresponding to label cᵢ in the label tree T_{AC}). Dₓⁱ is used for representing a subordination relationship between label cᵢ and the label tree T_{AC}. Dₓⁱ is 1 when label cᵢ belongs to the label tree T_{AC}. When label cᵢ does not belong to the label tree T_{AC}, Dₓⁱ is 0, and it indicates that there is no path between label cᵢ and label tⱼ in the label tree T_{AC}, namely label cᵢ may belong to another label tree. In the other label tree, a unit similarity between label cᵢ and a node label in the other label tree may be determined according to formula (1). f(⋅) represents a conversion function. The conversion function f(⋅) mainly multiplies-accumulates an edge weight of the path labels, namely mapping the edge weight of the path labels into a numerical value, also referred to as a path weight. A product of the confidence corresponding to label cᵢ, the confidence corresponding to label tⱼ and a path weight corresponding to each label path may be calculated to obtain p calculation results. The terminal device may select the maximum in the p calculation results as the unit similarity between label cᵢ and label tⱼ.

In order to calculate the set similarity between the first label set CL and the second label set Sₖ, the terminal device needs to calculate a unit similarity between each label in the first label set CL and each label in the second label set Sₖ according to formula (1), and may further select the maximum unit similarity in the unit similarities between label cᵢ and all the labels in the second label set Sₖ as a correlation weight between label cᵢ and the second label set Sₖ, specifically as shown in formula (2):

F(cᵢ,Sₖ)=max{F(cᵢ,tⱼ)|tⱼ∈Sₖ, j=1, 2, . . . , m} (2)

F(cᵢ, Sₖ) represents the correlation weight between label cᵢ and the second label set Sₖ. For example, when the second label set Sₖ includes three labels, i.e., label t₁, label t₂ and label t₃, it is calculated through formula (1) that a unit similarity between label c₁ in the first label set CL and label t₁ is similarity 1, a unit similarity between label c₁ and label t₂ is similarity 2, and a unit similarity between label c₁ and label t₃ is similarity 3. The maximum in similarity 1, similarity 2 and similarity 3 may be selected as a correlation weight between label c₁ and the second label set Sₖ according to formula (2).

After calculating the correlation weight between each label in the first label set CL and the second label set Sₖ, the terminal device may accumulate the correlation weight between each label in the first label set CL and the second label set Sₖ, and determine an accumulated value as the set similarity between the first label set CL and the second label set Sₖ, specifically as shown in formula (3):

F(CL,Sₖ)=sum{F(cᵢ,Sₖ)|cᵢ∈CL, i=1, 2, . . . , n} (3)

F(CL, Sₖ) represents the set similarity between the first label set CL and the second label set Sₖ. For example, when the first label set CL includes three labels, i.e., label c₁, label c₂ and label c₃, it may be calculated according to formula (2) that a correlation weight between label c₁ and the second label set Sₖ is weight 1, a correlation weight between label c₂ and the second label set Sₖ is weight 2, and a correlation weight between label c₃ and the second label set Sₖ is weight 3. The terminal device may accumulate weight 1, weight 2 and weight 3, and determine an accumulated value as the set similarity between the first label set CL and the second label set Sₖ.

The set similarities between the first label set CL and the k second label set/sets may be determined according to formula (1), formula (2) and formula (3).

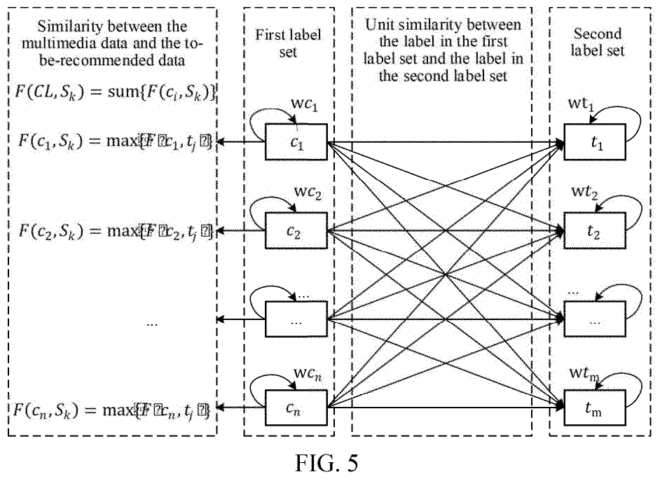

Referring to FIG. 5 together, a schematic diagram of determining a set similarity according to an embodiment of this application is shown. As shown in FIG. 5, the label set corresponding to the multimedia data is the first label set CL. The first label set CL includes n labels represented as label c₁, label c₂, . . . , and label cₙ, respectively. A confidence corresponding to label c₁ is wc₁, a confidence corresponding to label c₂ is wc₂, . . . , and a confidence corresponding to label cₙ is wcₙ. The to-be-recommended data set corresponding to the multimedia data may include K piece/pieces of to-be-recommended data. Each piece of to-be-recommended data corresponds to a label set. The second label set Sₖ includes m labels represented as label t₁, label t₂, . . . , and label tₘ respectively. A confidence corresponding to label t₁ is wt₁, a confidence corresponding to label t₂ is wt₂, . . . , and a confidence corresponding to label tₘ is wtₘ. The terminal device may calculate unit similarities between each label in the first label set CL and the m labels in the second label set Sₖ according to formula (1) respectively, such as a unit similarity between label c₁ and label t₁, a unit similarity between label c₁ and label t₂, and a unit similarity between label c₁ and label tₘ.

The terminal device may determine a similarity (also referred to as a correlation weight) between each label in the first label set CL and the second label set Sₖ according to formula (2), such as a correlation weight between label c₁ and the second label set Sₖ, a correlation weight between label c₂ and the second label set Sₖ, and a correlation weight between label cₙ and the second label set Sₖ. The set similarity between the first label set CL and the second label set Sₖ may further be determined according to formula (3). In such case, the set similarity is a similarity between the multimedia data and the to-be-recommended data corresponding to the second label set Sₖ. The terminal device may determine the similarity between the multimedia data and each piece of to-be-recommended data in the to-be-recommended data set according to the above-mentioned processing process.

Referring FIG. 3, in Step S105, target recommendation data matched with the multimedia data can be determined from the to-be-recommended data set according to the set similarity.

In an example, the terminal device may determine to-be-recommended data satisfying a preset condition in the to-be-recommended data set as the target recommendation data matched with the multimedia data according to the set similarity. The preset condition may include, but not limited to, a preset amount condition (for example, the amount of the target recommendation data does not exceed 10) and a preset similarity threshold condition (for example, the set similarity is more than or equal to 0.8).

The terminal device may sequence the to-be-recommended data in the to-be-recommended data according to an order from high to low set similarities, acquire the target recommendation data from the sequenced to-be-recommended data according to the sequencing order, and display the target recommendation data to the target user corresponding to the multimedia data. Of course, the target recommendation data may refer to the to-be-recommended data with the maximum set similarity in the to-be-recommended data set, or the first L pieces of to-be-recommended data in the sequenced to-be-recommended data set, L being a positive integer greater than 1.

In an example, the terminal device may detect a behavioral operation of the target user in real time when the multimedia data is video data. The terminal device may acquire the video data played by the target user when detecting a playing operation of the target user over the video data, and after determining target recommendation data matched with the video data, display the target recommendation data on a playing interface of the video data. For the target recommendation data displayed on the video playing interface, the target user may click to view detailed information of the displayed target recommendation data on the playing interface.

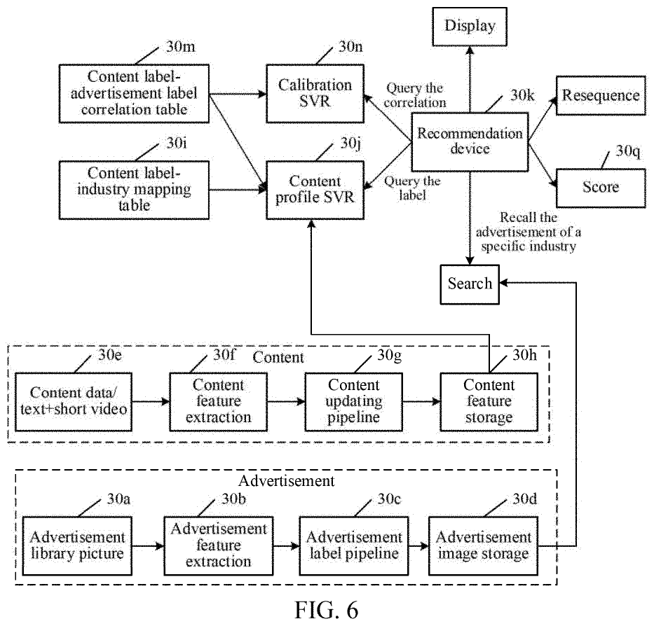

Referring to FIG. 6, a structural schematic diagram of a data recommendation system according to an embodiment of this application is shown. When the data recommendation solution is applied to a short video companion advertisement recommendation scene, the data recommendation system may be divided into the generation of a content label image, the generation of an advertisement label image, content label-advertisement label similarity calculation, and content-image-based industry search. Both the content label image and the advertisement label image are based on the same label system (i.e., label tree). Different industries may have different label systems.

As shown in FIG. 6, the advertisement image may be generated through the following process: an advertisement library picture 30a is acquired, advertisement feature extraction 30b is performed on the advertisement library picture 30a through an image recognition model to obtain an advertisement label corresponding to the advertisement library picture 30a, an advertisement image corresponding to the advertisement library picture 30a is generated from the extracted advertisement label through an advertisement label pipeline 30c, and advertisement image storage 30d is performed. The advertisement label pipeline 30c may be used for sorting the advertisement label according to dimensions of person, object, scene, event, etc., in the label system to generate the advertisement image corresponding to the advertisement library picture 30a and performing advertisement image storage 30a. The advertisement library picture 30a is an advertisement picture stored in an advertisement library. The advertisement library may be used for storing all advertisement data. In an example, the advertisement data may be stored in a picture form, and may further include a title description in a text form. For the title description in the advertisement data, an advertisement label corresponding to the advertisement data may be extracted from a title through a text recognition model, the advertisement image is generated from the advertisement label extracted from the title and the advertisement label corresponding to the advertisement library picture 30a, and advertisement image storage 30d is performed.

In an example, the content image may be generated through the following process: content data/text+short video 30e is acquired, content feature extraction 30f is performed on a short video through the image recognition model to extract a content feature in the short video, content feature extraction 30f is performed on content data/text through the text recognition model to extract a content feature in the content data/text, and content feature storage 30h is performed on both the content feature in the short video and the content feature in the content data/text. The content features corresponding to the content data/text+short video 30e are input to a content profile support vector regression (SVR) 30j, content labels corresponding to the content data/text+short video 30e may be determined according to the content profile SVR 30j, and the corresponding content image is generated. A content updating pipeline 30g may be used for screening and merging the content features extracted by the image recognition model and the text recognition model to obtain a more accurate content feature of the content data/text+short video 30e and performing content feature storage 30h.

In an example, the content-image-based industry search includes that: a recommendation device 30k may map the content labels corresponding to the content data/text+short video 30e to an advertised industry according to a content label-industry mapping table 30i, namely querying a target advertised industry corresponding to the content labels from the content label-industry mapping table 30i. An advertisement satisfying a user portrait and belonging to the target advertised industry in the advertisement library is determined as a to-be-recommended advertisement. All to-be-recommended advertisements form a to-be-recommended advertisement set. An advertisement label corresponding to the to-be-recommended advertisement is directly acquired from the stored advertisement image.

A content label-advertisement label correlation table 30m stores correlations between all content labels and advertisement labels (i.e., similarities between the content labels and the advertisement labels, which may be calculated according to formula (1)) in a key-value data structure. Correlations between the content labels corresponding to content data/text+short video 30e and the advertisement label corresponding to the to-be-recommended advertisement may be queried through a calibration SVR 30n to obtain a similarity (which may be calculated according to formula (2) and formula (3)) between the content data/text+short video 30e and the to-be-recommended advertisement. Herein, the similarity is a score 30q of the to-be-recommended advertisement. All the to-be-recommended advertisements are resequenced according to the score 30q of each to-be-recommended advertisement, and a target advertisement for displaying is determined from the resequenced to-be-recommended advertisements. The recommendation device 30k may be configured to recommend an advertisement highly correlated with a viewed content to a user, and may improve the matching degree between the recommended advertisement and the content data/text+short video 30e. The recommendation device (mixer) 30k may be a server, computer program (program code), intelligent terminal, cloud server, client, etc., with a recommendation function.

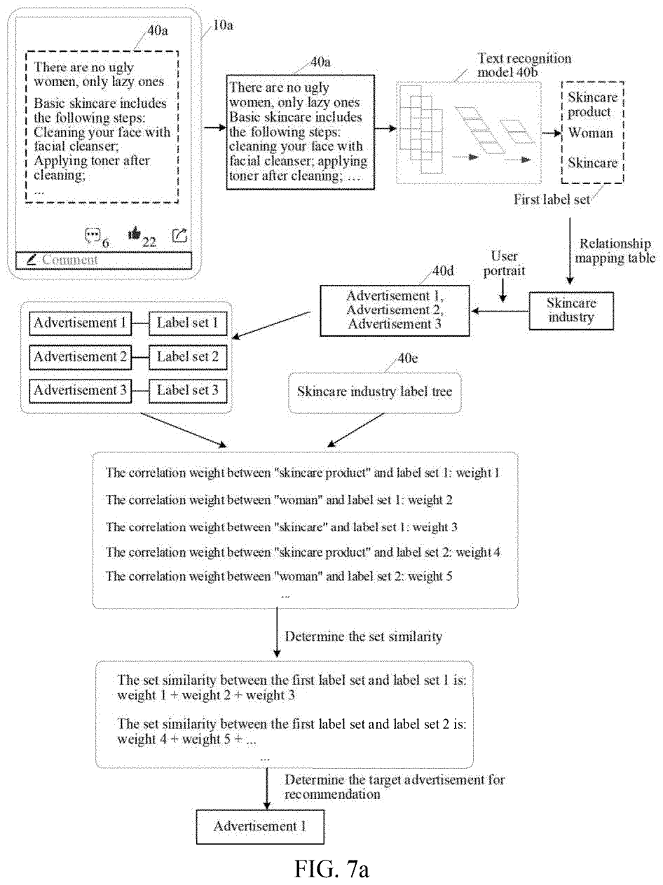

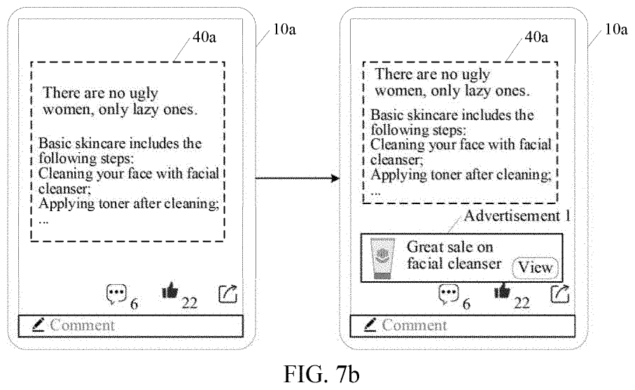

Referring to FIGS. 7a and 7b, schematic diagrams of a data recommendation scene according to an embodiment of this application are shown. As shown in FIG. 7a, information application software (the information application software may be configured to consume or process text information, image information, video information, etc.) may be installed in a terminal device 10a. When a user views text information through the terminal device 10a (for example, the user selects to browse an article 40a), the terminal device 10a may acquire the article 40a (including an article title and article content of the article 40a) currently browsed by the user. Since the article 40a includes text information described in Chinese, the terminal device 10a may perform word segmentation on a text in the article 40a to segment the text in the article 40a into multiple unit characters. Each unit character may refer to an independent character or a phrase.

The terminal device 10a may convert the multiple unit characters obtained by word segment into word vectors based on word embedding, namely converting the unit characters described in a natural language into word vectors understandable for a computer. The terminal device 10 may employ a text recognition model 40b. The text recognition model 40b may extract semantic features in the article 40a and recognize a label corresponding to the article 40a. The text recognition model includes, but not limited to, a convolutional neural network model, a concurrent neural network model, a deep neural network model, etc.

Afterwards, the terminal device 10a may input the word vector corresponding to the article 40a to the text recognition model 40b, extract a semantic feature corresponding to the article 40a from the input word vector according to the text recognition model 40b, determine matching probability values between the semantic feature and multiple attribute features (one attribute feature corresponds to one label) in the text recognition model 40b, determine a label that the semantic feature belongs to according to the matching probability values, and further determine that a first label set corresponding to the article 40a includes three labels, i.e., skincare product, woman, and skincare.

The terminal device 10a may acquire a relationship mapping table and determine from the relationship mapping table that a recommended industry corresponding to the first label set is a skincare industry. The terminal device 10a may acquire a user portrait corresponding to the above-mentioned user (i.e., the user browsing the article 40a through the terminal device 10a), search an advertisement library according to the first label set and the user portrait to find all advertisements matched with the user portrait and belonging to the skincare industry from the advertisement library as to-be-recommended advertisements corresponding to the article 40a, and form a to-be-recommended advertisement set 40d by the to-be-recommended advertisements. The to-be-recommended advertisement set 40d may include advertisement 1, advertisement 2, and advertisement 3. The relationship mapping table may be used for storing mapping relationships between article labels and advertised industries. The relationship mapping table may be pre-constructed. The pre-constructed relationship mapping table is stored.

The terminal device 10a may acquire a label set corresponding to each to-be-recommended advertisement in the to-be-recommended advertisement set 40d. For example, a label set corresponding to advertisement 1 is label set 1, a label set corresponding to advertisement 2 is label set 2, and a label set corresponding to advertisement 3 is label set 3. It may be understood that, for all advertisements in the advertisement library, corresponding labels may be extracted in advance based on the image recognition model and the text recognition model to obtain a label set corresponding to each advertisement in the advertisement library.

The terminal device 10a may acquire a pre-constructed skincare industry label tree 40e. For a structural form of the skincare industry label tree 40e, reference may be made to the embodiment corresponding to FIG. 4. The terminal device 10a may determine a unit similarity (which may be calculated according to formula (1)) between each label in the first label set and each label in the label set corresponding to the to-be-recommended advertisement according to the skincare industry label tree 40e, matching probability values (i.e., confidences) corresponding to the labels in the first label set, and matching probability values corresponding to the labels in the label set corresponding to the to-be-recommended advertisement. Correlation weights (which may be calculated according to formula (2)) between each label in the first label set and label set 1, label set 2 and label set, respectively may be determined according to the unit similarities. For example, the correlation weight between label “skincare product” and label set 1 is weight 1, the correlation weight between label “woman” and label set 1 is weight 2, and the correlation weight between label “skincare” and label set 1 is weight 3. Furthermore, the terminal device may add weight 1, weight 2 and weight 3 to obtain a numerical value as a set similarity between the first label set and label set 1. Similarly, a set similarity between the first label set and label set 2 and a set similarity between the first label set and label set 3 may be obtained. If the set similarity between the first label set and label set 1 is maximum, advertisement 1 corresponding to label set 1 may be determined as a target recommended advertisement matched with the article 40a.

As shown in FIG. 7b, the terminal device 10a, after determining that the target recommended advertisement corresponding to the article 40a is advertisement 1, may display advertisement 1 on a browsing interface of the article 40a. The user may click advertisement 1 on the browsing interface of the article 40a to view detailed information of advertisement 1.

According to the embodiments of this application, a first label set corresponding to multimedia data is acquired, the labels in the first label set being used for representing content attributes of the multimedia data. A to-be-recommended data set corresponding to the multimedia data and a second label set corresponding to to-be-recommended data in the to-be-recommended data set are acquired, the labels in the second label set being used for representing content attributes of the to-be-recommended data. A label tree may further be acquired. A set similarity between the first label set and the second label set is determined according to label positions of the labels in the first label set in the label tree and label positions of the labels in the second label set in the label tree. Target recommendation data matched with the multimedia data may be determined from the to-be-recommended data set according to the set similarity. It can be seen that the first label set may be extracted from the multimedia data, the second label set may be extracted from the to-be-recommended data, the similarity between the first label set and the second label set is calculated based on the pre-constructed label tree, and the target recommendation data matched with the multimedia data is further determined. Therefore, the matching degree between the target recommendation data and the multimedia data may be enhanced, and the data recommendation accuracy may further be improved.

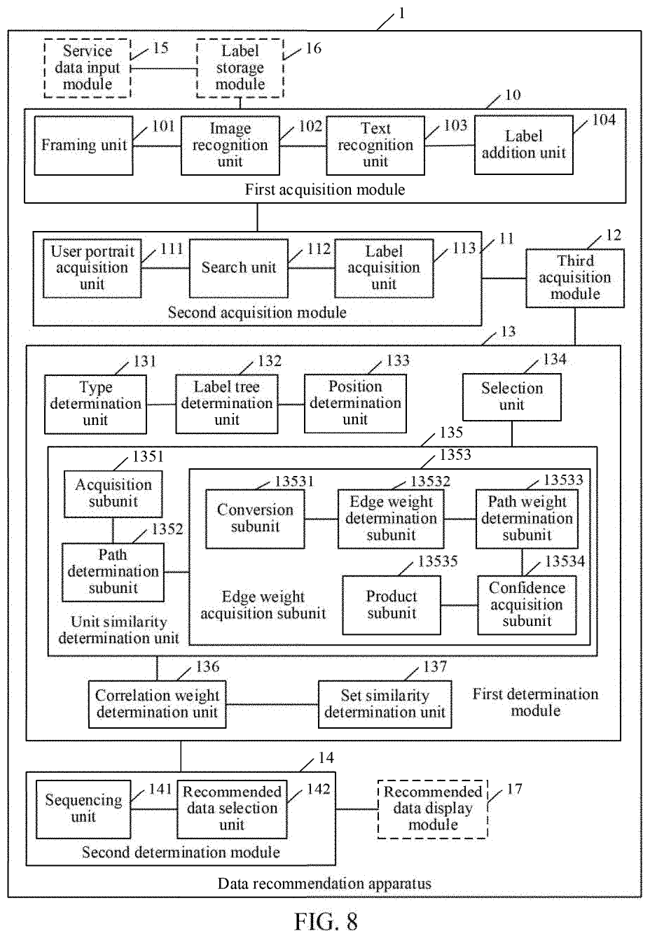

Referring to FIG. 8, a structural schematic diagram of a data recommendation apparatus according to an embodiment of this application is shown. In other examples, the data recommendation apparatus may be a computer program (including a program code) running in a computer device. For example, the data recommendation apparatus is application software. The apparatus may be configured to perform the corresponding steps in the methods described herein. As shown in FIG. 8, the data recommendation apparatus 1 may include a first acquisition module 10, a second acquisition module 11, a third acquisition module 12, a first determination module 13, and a second determination module 14.

The first acquisition module 10 is configured to acquire a first label set corresponding to multimedia data, the first label set including a label for representing a content attribute of the multimedia data.

The second acquisition module 11 is configured to acquire a to-be-recommended data set and a second label set corresponding to to-be-recommended data in the to-be-recommended data set, the second label set including a label for representing a content attribute of the to-be-recommended data.

The third acquisition module 12 is configured to acquire a label tree, the label tree including at least two labels in a tree-like hierarchical relationship, and the at least two labels including the label in the first label set and the label in the second label set.

The first determination module 13 is configured to determine a set similarity between the first label set and the second label set according to a label position of the label in the first label set in the label tree and a label position of the label in the second label set in the label tree.

The second determination module 14 is configured to determine target recommendation data matched with the multimedia data from the to-be-recommended data set according to the set similarity.

For specific implementations of the functions of the first acquisition module 10, the second acquisition module 11, the third acquisition module 12, the first determination module 13 and the second determination module 14, reference may be made to steps S101 to S105 in the embodiment corresponding to FIG. 3, and the details will not be repeatedly described herein.

Referring to FIG. 8 together, the data recommendation apparatus 1 further includes a service data input module 15, a label storage module 16, and a recommended data display module 17.

The service data input module 15 is configured to acquire the service data in the recommendation database and input the service data to an image recognition model.

The label storage module 16 is configured to acquire the label corresponding to the service data from the image recognition model and store the label corresponding to the service data in the recommendation data label library.

The recommended data display module 17 is configured to recommend the target recommendation data to a target user, and display the target recommendation data on a playing interface of the video data in response to detecting a playing operation of the target user over the video data.

For specific implementations of the functions of the service data input module 15 and the label storage module 16, reference may be made to step S102 in the embodiment corresponding to FIG. 3. For a specific implementation of the function of the recommended data display module 17, reference may be made to step S105 in the embodiment corresponding to FIG. 3, and the details will not be repeatedly described herein.

Referring to FIG. 8 together, when the multimedia data includes video data and text data corresponding to the video data, the first acquisition module 10 may include a framing unit 101, an image recognition unit 102, a text recognition unit 103, and a label addition unit 104.

The framing unit 101 is configured to acquire the multimedia data and frame the video data in the multimedia data to obtain at least two pieces of image data corresponding to the video data.

The image recognition unit 102 is configured to input the at least two pieces of image data to an image recognition model and acquire labels respectively corresponding to the at least two pieces of image data in the image recognition model.

The text recognition unit 103 is configured to input the text data in the multimedia data to a text recognition model and acquire a label corresponding to the text data in the text recognition model.

The label addition unit 104 is configured to add the labels respectively corresponding to the at least two pieces of image data and the label corresponding to the text data to the first label set.

For specific implementations of the functions of the framing unit 101, the image recognition unit 102, the text recognition unit 103 and the label addition unit 104, reference may be made to step S101 in the embodiment corresponding to FIG. 3, and the details will not be repeatedly described herein.

Referring to FIG. 8 together, the second acquisition module 11 may include a user portrait acquisition unit 111, a search unit 112, and a label acquisition unit 113.

The user portrait acquisition unit 111 is configured to acquire a target user corresponding to the multimedia data and a user portrait corresponding to the target user.

The search unit 112 is configured to search a recommendation database according to the user portrait and the recommendation type, determine found service data as the to-be-recommended data, and add the to-be-recommended data to the to-be-recommended data set, the recommendation database including service data for recommendation.

The label acquisition unit 113 is configured to acquire a label corresponding to the to-be-recommended data from a recommendation data label library, and add the label to the second label set, the recommendation data label library being used for storing a label corresponding to the service data in the recommendation database.

For specific implementations of the functions of the user portrait acquisition unit 111, the search unit 112 and the label acquisition unit 113, reference may be made to step S102 in the embodiment corresponding to FIG. 3, and the details will not be repeatedly described herein.

Referring to FIG. 8 together, the first determination unit 13 may include a type determination unit 131, a label tree determination unit 132, a position determination unit 133, a selection unit 134, a unit similarity determination unit 135, a correlation weight determination unit 136, and a set similarity determination unit 137.

The type determination unit 131 is configured to acquire a relationship mapping table, and acquire a recommendation type corresponding to the first label set from the relationship mapping table, the relationship mapping table being used for storing mapping relationships between the at least two labels and recommendation types.

The label tree determination unit 132 is configured to determine a sub label tree corresponding to the recommendation type from the label tree according to the recommendation type.

The position determination unit 133 is configured to determine the set similarity between the first label set and the second label set according to a label position of the first label set in the sub label tree and a label position of the second label set in the sub label tree.

The selection unit 134 is configured to acquire a label cᵢin the first label set, and acquire a second label set Sₖ, i being a positive integer less than or equal to a label count of the first label set, and k being a positive integer less than or equal to the amount of the to-be-recommended data.

The unit similarity determination module 135 is configured to determine a unit similarity between the label cᵢ and each label in the second label set Sₖ according to a label position of the label cᵢ in the label tree and a label position of the label in the second label set Sₖ in the label tree.

The correlation weight determination unit 136 is configured to determine the maximum unit similarity as a correlation weight between the label cᵢ and the second label set Sₖ.

The set similarity determination unit 137 is configured to accumulate a correlation weight between each label in the first label set and the second label set Sₖ to obtain a set similarity between the first label set and the second label set Sₖ.

For specific implementations of the functions of the type determination unit 131, the label tree determination unit 132, the position determination unit 133, the selection unit 134, the unit similarity determination unit 135, the correlation weight determination unit 136 and the set similarity determination unit 137, reference may be made to step S104 in the embodiment corresponding to FIG. 3, and the details will not be repeatedly described herein.

Referring to FIG. 8 together, the unit similarity determination unit 135 may include an acquisition subunit 1351, a path determination subunit 1352, and an edge weight acquisition subunit 1353.

The acquisition subunit 1351 is configured to acquire a label tⱼ in the second label set Sₖ, j being a positive integer less than or equal to a label count of the second label set Sₖ.

The path determination subunit 1352 is configured to determine a label between the label cᵢ and the label tⱼ in the label tree according to the label position of the label cᵢ in the label tree and a label position of the label tⱼ in the label tree.

The edge weight acquisition subunit 1353 is configured to acquire an edge weight between two adjacent labels in the label tree, and determine a unit similarity between the label cᵢ and the label tⱼ according to an edge weight in the label path.

For specific implementations of the functions of the acquisition subunit 1351, the path determination subunit 1352 and the edge weight acquisition subunit 1353, reference may be made to step S104 in the embodiment corresponding to FIG. 3, and the details will not be repeatedly described herein.

Referring to FIG. 8 together, the edge weight acquisition subunit 1353 may include a conversion subunit 13531, an edge weight determination subunit 13532, a path weight determination subunit 13533, a confidence acquisition subunit 13534, and a product subunit 13535.

The conversion subunit 13531 is configured to acquire the labels in the label tree and generate a word vector corresponding to each label in the label tree.

The edge weight determination subunit 13532 is configured to acquire a vector similarity between the word vectors corresponding to two adjacent labels in the label tree, and determine the vector similarity as an edge weight between ate two adjacent labels in the label tree.

The path weight determination subunit 13533 is configured to determine a path weight corresponding to the label path according to an edge weight in the label path.

The confidence acquisition subunit 13534 is configured to acquire a first confidence corresponding to the label cᵢ and a second confidence corresponding to the label tⱼ.

The product subunit 13535 is configured to perform a product operation on the first confidence, the second confidence and the path weight to obtain the unit similarity between the label cᵢ and the label tⱼ.

For specific implementations of the functions of the conversion subunit 13531, the edge weight determination subunit 13532, the path weight determination subunit 13533, the confidence acquisition subunit 13534 and the product subunit 13535, reference may be made to step S104 in the embodiment corresponding to FIG. 3, and the details will not be repeatedly described herein.

Referring to FIG. 8 together, the second determination module 14 may include a sequencing unit 141 and a recommended data selection unit 142.

The sequencing unit 141 is configured to sequence the to-be-recommended data in the to-be-recommended data set according to the set similarity.

The recommended data selection unit 142 is configured to acquire the target recommendation data from the sequenced to-be-recommended data according to a sequencing order, and display the target recommendation data to a target user corresponding to the multimedia data.

For specific implementations of the functions of the sequencing unit 141 and the recommended data selection unit 142, reference may be made to step S105 in the embodiment corresponding to FIG. 3, and the details will not be repeatedly described herein.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

According to the embodiments of this application, a first label set corresponding to multimedia data is acquired, the labels in the first label set being used for representing content attributes of the multimedia data. A to-be-recommended data set corresponding to the multimedia data and a second label set corresponding to to-be-recommended data in the to-be-recommended data set are acquired, the labels in the second label set being used for representing content attributes of the to-be-recommended data. A label tree may further be acquired. A set similarity between the first label set and the second label set is determined according to label positions of the labels in the first label set in the label tree and label positions of the labels in the second label set in the label tree. Target recommendation data matched with the multimedia data may be determined from the to-be-recommended data set according to the set similarity. It can be seen that the first label set may be extracted from the multimedia data, the second label set may be extracted from the to-be-recommended data, the similarity between the first label set and the second label set is calculated based on the pre-constructed label tree, and the target recommendation data matched with the multimedia data is further determined. Therefore, the matching degree between the target recommendation data and the multimedia data may be enhanced, and the data recommendation accuracy may further be improved.

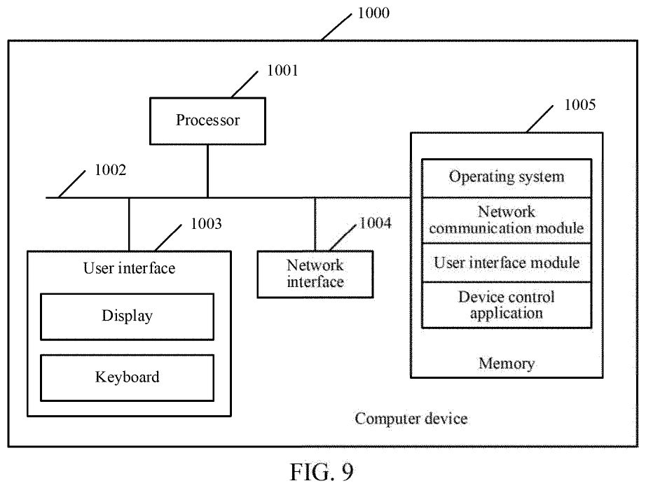

FIG. 9 is a structural schematic diagram of a computer device according to an embodiment of this application. As shown in FIG. 9, a computer device 1000 may include: a processor 1001 including processing circuitry, a network interface 1004, and a memory 1005 (a non-transitory storage medium). Besides, the computer device 1000 may further include: a user interface 1003 and at least one communication bus 1002. The communication bus 1002 is configured to implement connection and communication between the components. The user interface 1003 may include a display, a keyboard, and optionally, the user interface 1003 may further include a standard wired interface and a standard wireless interface. Optionally, the network interface 1004 may include a standard wired interface and a standard wireless interface (such as a Wi-Fi interface). The memory 1004 may be a high-speed random access memory (RAM), or may be a non-volatile memory, for example, at least one magnetic disk memory. Optionally, the memory 1005 may be further at least one storage apparatus away from the processor 1001. As shown in FIG. 9, the memory 1005 used as a computer-readable storage medium may include an operating system, a network communication module, a user interface module, and a device-control application program.

In the electronic device 1000 shown in FIG. 9, the network interface 1004 may provide a network communication function; the user interface 1003 is mainly configured to provide an input interface for a user; and the processor 1001 may be configured to invoke the computer program stored in the memory 1005, to implement the following steps: acquiring a first label set corresponding to multimedia data, the first label set including a label for representing a content attribute of the multimedia data; acquiring a to-be-recommended data set and a second label set corresponding to to-be-recommended data in the to-be-recommended data set, the second label set including a label for representing a content attribute of the to-be-recommended data; acquiring a label tree, the label tree including at least two labels in a tree-like hierarchical relationship, and the at least two labels including the label in the first label set and the label in the second label set; determining a set similarity between the first label set and the second label set according to a label position of the label in the first label set in the label tree and a label position of the label in the second label set in the label tree; and determining target recommendation data matched with the multimedia data from the to-be-recommended data set according to the set similarity.

It is to be understood that the computer device 1000 described herein may perform the descriptions about the data recommendation method corresponding to FIG. 3, or the descriptions about the data recommendation apparatus in the embodiment corresponding to FIG. 8.

In addition, an embodiment of this application also provides a non-transitory computer-readable storage medium. A computer program executed by the above-mentioned data recommendation apparatus 1 (that includes processing circuitry) is stored in the computer-readable storage medium. The computer program includes a program instruction which, when executed by a processor, may enable a computer device including the processor to perform the methods described herein. As an example, the program instruction may be deployed in a computing device for execution, or executed in multiple computing devices at the same place, or executed in multiple computing devices interconnected through a communication network at multiple places. The multiple computing device interconnected through the communication network at multiple places may form a blockchain system.

A person of ordinary skill in the art is to be understood that all or a part of the processes of the methods in the foregoing embodiments may be implemented by a program instructing relevant hardware. The program may be stored in a non-transitory computer-readable storage medium. When the program is executed, the program may include the procedures of the embodiments of the foregoing methods. The storage medium may be a magnetic disk, an optical disk, a read-only memory (ROM), a random access memory (RAM), or the like.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data recommendation method, comprising:
acquiring, by processing circuitry, a first label set corresponding to multimedia data, the first label set comprising at least one label each representing a content attribute of the multimedia data;
acquiring, by the processing circuitry, a to-be-recommended data set including at least one to-be-recommended data and at least one second label set each corresponding to one of the at least one to-be-recommended data in the to-be-recommended data set, each second label set comprising at least one label each representing a content attribute of the respective to-be-recommended data;
acquiring, by the processing circuitry, a label tree, the label tree comprising a plurality of labels in a tree-structured hierarchical relationship, and the labels in the label tree including labels corresponding to the at least one label in the first label set and the at least one label in the at least one second label set;
determining, by the processing circuitry, a set similarity between the first label set and each of the at least one second label set according to label positions of the at least one label in the first label set in the label tree and label positions of the at least one label in each of the at least one second label set in the label tree;
determining, by the processing circuitry, target recommendation data matched with the multimedia data from the to-be-recommended data set according to the set similarity between the first label set and each of the at least one second label set; and
recommending, by the processing circuitry, the target recommendation data to a target user for displaying the target recommendation data on a displaying interface.

2. The method according to claim 1, wherein the multimedia data comprises video data and text data corresponding to the video data, and the acquiring the first label set comprises:
determining a frame of image data from the video data;
inputting the frame of image data to an image recognition model to generate a label corresponding to the video data;
inputting the text data in the multimedia data to a text recognition model to generate a label corresponding to the text data; and
adding the labels respectively corresponding to the video data and the label corresponding to the text data to the first label set.

3. The method according to claim 1, wherein the determining the set similarity comprises:
acquiring a recommendation type corresponding to the first label set based on a relationship mapping table, the relationship mapping table being used for storing mapping relationships between labels and recommendation types;
determining a sub label tree corresponding to the recommendation type from the label tree according to the recommendation type; and
determining the set similarity between the first label set and each of the at least one second label set according to label positions of the first label set in the sub label tree and label positions of the at least one second label set in the sub label tree.

4. The method according to claim 3, wherein the acquiring the to-be-recommended data set including at least one to-be-recommended data and the at least one second label set each corresponding to one of the at least one to-be-recommended data in the to-be-recommended data set comprises:
determining a target user corresponding to the multimedia data and a user portrait corresponding to the target user;
searching for service data from a recommendation database according to the user portrait and the recommendation type, the service data found from the recommendation database being used as the at least one to-be-recommended data in the to-be-recommended data set; and
acquiring the at least one label corresponding to each of the at least one to-be-recommended data from a recommendation data label library, and adding the at least one label to the respective second label set, the recommendation data label library being used for storing labels corresponding to the service data in the recommendation database.

5. The method according to claim 4, further comprising:
inputting the service data in the recommendation database to an image recognition model; and
acquiring the labels corresponding to the service data from the image recognition model, and storing the labels corresponding to the service data in the recommendation data label library.

6. The method according to claim 1, wherein the determining the set similarity comprises:
acquiring a label cᵢ in the first label set, and acquiring a second label set Sₖ from the at least one second label set, i being a positive integer less than or equal to a label count of the first label set, and k being a positive integer less than or equal to the amount of the at least one to-be-recommended data;
determining a unit similarity between the label cᵢ and each label in the second label set Sₖ according to a label position of the label cᵢ in the label tree and a label position of each label in the second label set Sₖ in the label tree;
determining the maximum unit similarity as a correlation weight between the label cᵢ and the second label set Sₖ; and
accumulating correlation weights between each label in the first label set and the second label set Sₖ to obtain a set similarity between the first label set and the second label set Sₖ.

7. The method according to claim 6, wherein the determining the unit similarity comprises:
acquiring a label tⱼ in the second label set Sₖ, j being a positive integer less than or equal to a label count of the second label set Sₖ;
determining a label path between the label cᵢ and the label tⱼ in the label tree according to the label position of the label cᵢ in the label tree and a label position of the label tⱼ in the label tree;
acquiring an edge weight between two adjacent labels in the label tree; and
determining a unit similarity between the label cᵢ and the label tⱼ according to an edge weight in the label path.

8. The method according to claim 7, wherein the acquiring the edge weight between two adjacent labels in the label tree comprises:
acquiring the labels in the label tree and generating a word vector corresponding to each label in the label tree; and
acquiring a vector similarity between the word vectors corresponding to two adjacent labels in the label tree, and determining the vector similarity as the edge weight between the two adjacent labels in the label tree.

9. The method according to claim 7, wherein the determining the unit similarity between the label cᵢ and the label tⱼ according to the edge weight in the label path comprises:
determining a path weight corresponding to the label path according to the edge weight in the label path;
acquiring a first confidence corresponding to the label cᵢ and a second confidence corresponding to the label tⱼ; and
performing a product operation on the first confidence, the second confidence and the path weight to obtain the unit similarity between the label cᵢ and the label tⱼ.

10. The method according to claim 1, wherein the determining the target recommendation data comprises:
sequencing the at least one to-be-recommended data in the to-be-recommended data set according to the set similarity corresponding to each of the at least one to-be-recommended data; and
acquiring the target recommendation data from the sequenced to-be-recommended data according to a sequencing order.

11. A data recommendation apparatus, comprising:
processing circuitry configured to:
acquire a first label set corresponding to multimedia data, the first label set comprising at least one label each representing a content attribute of the multimedia data;
acquire a to-be-recommended data set including at least one to-be-recommended data and at least one second label set each corresponding to one of the at least one to-be-recommended data in the to-be-recommended data set, each second label set comprising at least one label each representing a content attribute of the respective to-be-recommended data;
acquire a label tree, the label tree comprising a plurality of labels in a tree-structured hierarchical relationship, and the labels in the label tree including labels corresponding to the at least one label in the first label set and the at least one label in the at least one second label set;
determine a set similarity between the first label set and each of the at least one second label set according to label positions of the at least one label in the first label set in the label tree and label positions of the at least one label in each of the at least one second label set in the label tree;
determine target recommendation data matched with the multimedia data from the to-be-recommended data set according to the set similarity between the first label set and each of the at least one second label set; and
recommend the target recommendation data to a target user for displaying the target recommendation data on a displaying interface.

12. The apparatus according to claim 11, wherein the multimedia data comprises video data and text data corresponding to the video data, and the processing circuitry is further configured to:
determine a frame of image data from the video data;
input the frame of image data to an image recognition model to generate a label corresponding to the video data;
input the text data in the multimedia data to a text recognition model to generate a label corresponding to the text data; and
add the labels respectively corresponding to the video data and the label corresponding to the text data to the first label set.

13. The apparatus according to claim 11, wherein the processing circuitry is further configured to:
acquire a recommendation type corresponding to the first label set based on a relationship mapping table, the relationship mapping table being used for storing mapping relationships between labels and recommendation types;
determine a sub label tree corresponding to the recommendation type from the label tree according to the recommendation type; and
determine the set similarity between the first label set and each of the at least one second label set according to label positions of the first label set in the sub label tree and label positions of the at least one second label set in the sub label tree.

14. The apparatus according to claim 13, wherein the processing circuitry is further configured to:
determine a target user corresponding to the multimedia data and a user portrait corresponding to the target user;
search for service data from a recommendation database according to the user portrait and the recommendation type, the service data found from the recommendation database being used as the at least one to-be-recommended data in the to-be-recommended data set; and
acquire the at least one label corresponding to each of the at least one to-be-recommended data from a recommendation data label library, and adding the at least one label to the respective second label set, the recommendation data label library being used for storing labels corresponding to the service data in the recommendation database.

15. The apparatus according to claim 14, wherein the processing circuitry is further configured to:
input the service data in the recommendation database to an image recognition model; and
acquire the labels corresponding to the service data from the image recognition model, and storing the labels corresponding to the service data in the recommendation data label library.

16. The apparatus according to claim 11, wherein the processing circuitry is further configured to:
acquire a label cᵢ in the first label set, and acquiring a second label set Sₖ from the at least one second label set, i being a positive integer less than or equal to a label count of the first label set, and k being a positive integer less than or equal to the amount of the at least one to-be-recommended data;
determine a unit similarity between the label cᵢ and each label in the second label set Sₖ according to a label position of the label cᵢ in the label tree and a label position of each label in the second label set Sₖ in the label tree;
determine the maximum unit similarity as a correlation weight between the label cᵢ and the second label set Sₖ; and
accumulate correlation weights between each label in the first label set and the second label set Sₖ to obtain a set similarity between the first label set and the second label set Sₖ.

17. The apparatus according to claim 16, wherein the processing circuitry is further configured to:
acquire a label tⱼ in the second label set Sₖ, j being a positive integer less than or equal to a label count of the second label set Sₖ;
determine a label path between the label cᵢ and the label tⱼ in the label tree according to the label position of the label cᵢ in the label tree and a label position of the label tⱼ in the label tree;
acquire an edge weight between two adjacent labels in the label tree; and
determine a unit similarity between the label cᵢ and the label tⱼ according to an edge weight in the label path.

18. The apparatus according to claim 17, wherein the processing circuitry is further configured to:
acquire the labels in the label tree, and generating a word vector corresponding to each label in the label tree; and
acquire a vector similarity between the word vectors corresponding to two adjacent labels in the label tree, and determining the vector similarity as the edge weight between the two adjacent labels in the label tree.

19. The apparatus according to claim 17, wherein the processing circuitry is further configured to:
determine a path weight corresponding to the label path according to the edge weight in the label path;
acquire a first confidence corresponding to the label cᵢ and a second confidence corresponding to the label tⱼ; and
perform a product operation on the first confidence, the second confidence and the path weight to obtain the unit similarity between the label cᵢ and the label tⱼ.

20. A non-transitory computer-readable storage medium storing instructions which when executed by at least one processor cause the at least one processor to perform
acquiring a first label set corresponding to multimedia data, the first label set comprising at least one label each representing a content attribute of the multimedia data;
acquiring a to-be-recommended data set including at least one to-be-recommended data and at least one second label set each corresponding to one of the at least one to-be-recommended data in the to-be-recommended data set, each second label set comprising at least one label each representing a content attribute of the respective to-be-recommended data;
acquiring a label tree, the label tree comprising a plurality of labels in a tree-structured hierarchical relationship, and the labels in the label tree including labels corresponding to the at least one label in the first label set and the at least one label in the at least one second label set;
determining a set similarity between the first label set and each of the at least one second label set according to label positions of the at least one label in the first label set in the label tree and label positions of the at least one label in each of the at least one second label set in the label tree;
determining target recommendation data matched with the multimedia data from the to-be-recommended data set according to the set similarity between the first label set and each of the at least one second label set; and
recommending the target recommendation data to a target user for displaying the target recommendation data on a displaying interface.
